(19) United States
(12) Patent Application Publication
(10) Pub. No.: US 2010/0309285 A1
(43) Pub. Date: Dec. 9, 2010

(54) Technique For Maintaining Eye Contact In A Videoconference Using A Display Device

(75) Inventor: Cristian A. Bolle, Bridgewater, NJ (US)

Correspondence Address: Docket Administrator - Room 3D-201E;Alcatel-Lucent USA Inc., 600-700 Mountain Avenue, Murray Hill, NJ, 07974, US

(73) Assignee: Alcatel-Lucent USA Inc., Murray Hill, NJ (US)

(21) Appl. No.: 12/858,632

(22) Filed: Aug. 18, 2010

Related U.S. Application Data
(63) Continuation-in-part of application No. 12/472,250, filed on May 26, 2009.
Application No. 12/472,250 is a continuation-in-part of application No. 12/238,096, filed on Sep. 25, 2008.

(51) Int. Cl. H04N 7/15

(52) U.S. Cl. 348/14.16; 348/E07.083

(57) ABSTRACT

In a videoconferencing terminal, a flat panel display has thereon display elements for displaying an image of a remote object during a videoconference. The display elements are arranged on the flat panel display such that light-transmissive regions are interspersed among the display elements. A camera in the terminal is used to receive light through the light-transmissive regions to capture an image of an object in front of the flat panel display to realize the videoconference.

### CROSS-REFERENCE TO RELATED APPLICATIONS

This application is a continuation-in-part of (a) U.S. patent application Ser. No. 12/472,250, filed on May 26, 2009, and (b) patent application Ser. No. 12/238,096, filed on Sep. 25, 2008, both of which are incorporated herein by reference in their entirety.

### TECHNICAL FIELD

The invention is directed, in general, to videoconferencing terminals which allow maintaining eye contact between or among participants in a videoconference.

### BACKGROUND OF THE INVENTION

This section introduces aspects that may help facilitate a better understanding of the invention. Accordingly, the statements of this section arc to be read in this light and are not to be understood as admissions about what is prior art or what is not prior art.

Communication via computer networks frequently involves far more than transmitting text. Computer networks, such as the Internet, can also be used for audio communication and visual communication. Still images and video are examples of visual data that may be transmitted over such networks.

One or more cameras may be coupled to a personal computer (PC) to provide visual communication. The camera or cameras can then be used to transmit real-time visual information, such as video, over a computer network. Dual transmission can be used to allow audio transmission with the video information. Whether in one-to-one communication sessions or through videoconferencing with multiple participants, participants can communicate via audio and video in real time over a computer network (i.e., voice-video communication). The visual images transmitted during voice-video communication sessions depend on the placement of the camera or cameras.

### BRIEF SUMMARY

Some embodiments provide for voice-video communications in which a participant can maintain eye contact. In these embodiments, the camera(s) and viewing screen are located together to reduce or eliminate a location disparity that could otherwise cause the participant to not look into the camera while watching the received image.

In one embodiment, a terminal is used by a participant which includes a display device having thereon display elements for displaying a selected image. For example, the selected image may be displayed based on light-reflective display technology. The display elements are arranged two-dimensionally on the display device such that light-transmissive regions are interspersed among the display elements on the display device. A camera is configured on one side of the display device to receive light through the light-transmissive regions to capture an image of an object, e.g., the participant, on the other side of the display device, thereby advantageously allowing the participant to look into the camera and maintain eye contact during the communications.

### BRIEF DESCRIPTION OF THE DRAWINGS

FIG. 1 is a schematic block diagram of an embodiment of a videoconferencing infrastructure within which a videoconferencing terminal constructed according to the principles of the invention may operate;

FIG. 2 is a schematic side elevation view of an embodiment of a videoconferencing terminal, e.g., of the videoconferencing infrastructure of FIG. 1, constructed according to the principles of the invention;

FIG. 3 is a flow diagram of one embodiment of a method of videoconferencing carried out according to the principles of the invention;

FIG. 4 is a schematic side elevation view of a second embodiment of a videoconferencing terminal constructed according to the principles of the invention; and

FIG. 5 is a schematic side elevation view of a third embodiment of a videoconferencing terminal constructed according to the principles of the invention.

### DETAILED DESCRIPTION

In a videoconference, establishing eye contact between the participants greatly enhances the feeling of intimacy. Unfortunately, the display and camera in many conventional videoconferencing terminals are not aligned. The resulting parallax prevents eye contact from being established between participants of the videoconference.

Sonic videoconferencing terminals address the eye contact-problem by using a large, tilted two way mirror to superimpose the camera position with the center of the display. Regrettably, this approach is bulky, frustrating the modem trend toward flat displays. Other videoconferencing terminals employ digital image-based rendering to recreate a central, eye contact view from multiple side views. One disadvantage of this approach is that it requires multiple cameras, significant image processing power and often yields unsuitable results.

Disclosed herein are embodiments of a videoconferencing terminal in which the camera is placed behind or within a modified flat panel display (FPD) such that the camera looks through the display at an object to be imaged (e.g., a participant in a videoconference). In one embodiment, the modified FPD is fabricated on a substantially transparent substrate. The substantially transparent substrate, for example, may be glass. In other embodiments, the substantially transparent substrate may be another substrate that is transparent to visible light or is transparent to one or more frequency segments of the visible light spectrum. In yet other embodiments, the substrate may have apertures thereon to let light therethrough.

In one embodiment, the pixels in the modified FPD are a combination of substantially transparent regions and light emitting areas that include electronic light sources, e.g., light emitting diodes (LEDs). The modified FPD includes the necessary addressing electronics for the electronic light sources. An array of the electronic light sources can be embedded in an active layer of electronics and pixel addressing logic used to address the electronic light sources. The electronic light sources can be either white or color electronic light sources that are used to render an image, such as, an image of a remotely located video-conference participant. The color electronic light sources may be arranged in a cluster of red, green, and blue electronic light sources that are driven together to form a full-color pixel. The substantially transparent regions of the modified FPD are used to capture the image of an object, such as a local video conference participant, through the substantially transparent regions of the modified FPD. In an alternative embodiment, the substantially transparent regions are replaced by apertures extending entirely through the modified FPD or, in other words, openings therethrough.

The modified FPD with a combination of the substantially transparent regions and the electronic light sources allow the modified FPD to simultaneously display and capture images without the need for synchronization. Digital processing of the captured images may be used to remove undesired diffraction which may be caused by the substantially transparent regions. The camera may include the necessary optical processing to remove diffraction or other artifacts from the captured images. Post-processing of optical images is well known in the art. A filter, such as a spatial light filter may also be used to reduce diffraction. With the benefit of various embodiments of the videoconferencing terminal described herein, it is possible for a videoconferencing participant to appear to maintain eye contact with the other participants, and experience a feeling of intimacy in the videoconference.

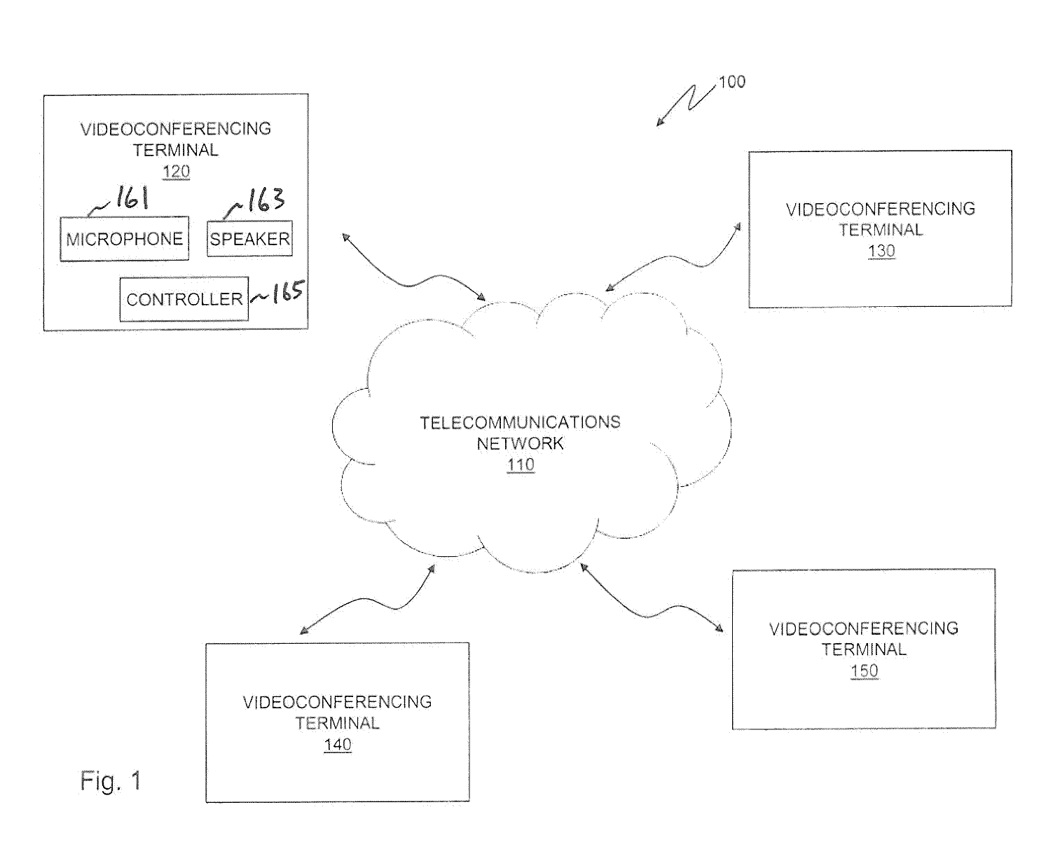

FIG. 1 is a schematic block diagram of one embodiment of a videoconferencing infrastructure 100 within which a videoconferencing terminal constructed according to the principles of the disclosure may operate. This embodiment of the videoconferencing infrastructure 100 is centered about a telecommunications network 110 that is employed to interconnect two or more videoconferencing terminals 120, 130, 140, 150 for communication of video signals or information, and perhaps also audio signals or information, therebetween. An alternative embodiment of the videoconferencing infrastructure 100 is centered about a computer network, such as the Internet. Still another embodiment of the videoconferencing infrastructure 100 involves a direct connection between two videoconferencing terminals, e.g., connection of the videoconferencing terminals 120, 130 via a plain old telephone (POTS) network. As represented in the videoconferencing terminal 120, the videoconferencing terminals 120, 130, 140, 150, may include components typically included in a conventional videoconferencing terminal, such as, a microphone 161, a speaker 163 and a controller 165. The microphone 161 can be configured to generate an audio signal based on acoustic energy received thereby, and the speaker 163 can be configured to generate acoustic energy based on an audio signal received thereby.

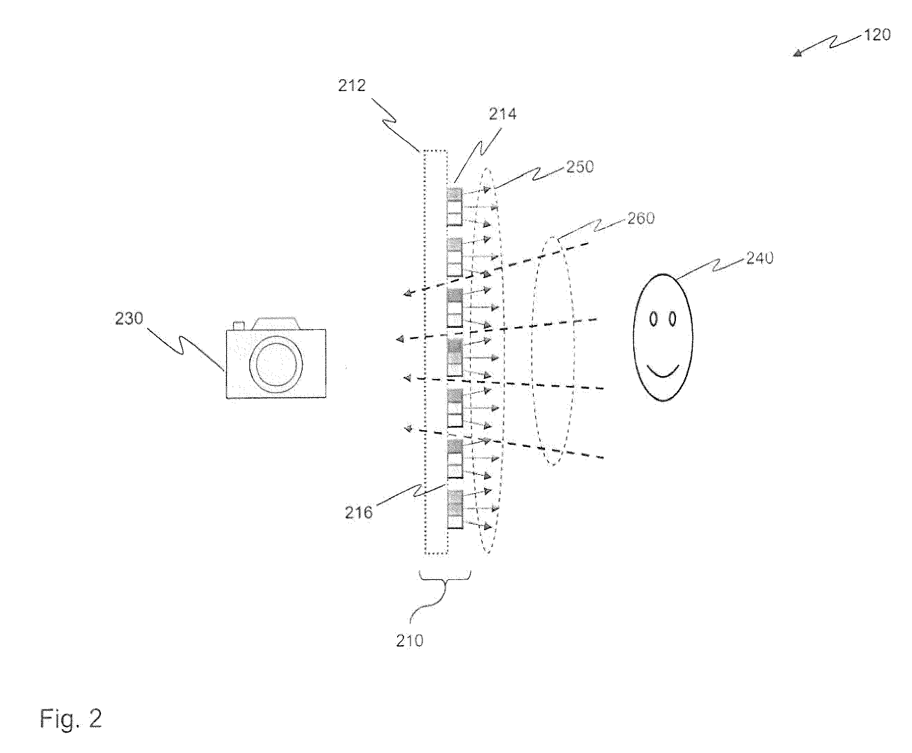

FIG. 2 is a side elevation view of an embodiment of a videoconferencing terminal, e.g., the videoconferencing terminal 120 of FIG. 1, constructed according to the principles of the invention. The videoconferencing terminal 120 is configured to operate in concurrent image display and image acquisition modes. The videoconferencing terminal 120 includes an FPD 210 that may be considered a modified FPD. The videoconferencing terminal 120 also includes a camera 230. Additionally, the videoconferencing terminal 120 may include additional components typically included in a conventional videoconferencing terminal. For example, the videoconferencing terminal 120 may include a microphone 161, a speaker 163 and a controller 165 that directs the operation of the videoconferencing terminal 120. The microphone 161 may be associated with the controller 165 and the speaker 163 may also be associated with the controller 165.

The FPD 210 is fabricated on a substantially transparent substrate 212. The substantially transparent substrate 212 may be a conventional transparent substrate that is commonly used in conventional FPDs, such as a conventional liquid crystal display (LCD). For example, the substantially transparent substrate 212 may be an EAGLE²⁰⁰⁰®, an EAGLE XG™, or another LCD glass manufactured by Corning Incorporated of Corning, N.Y. The substantially transparent substrate 212 may also be an LCD glass manufactured by another company. In the illustrated embodiment, the FPD 210 includes the electronic light sources 214 that are separated by substantially transparent regions 216.

The substantially transparent regions 216 and the electronic light sources 214 of the FPD 210 are interspersed among each other. The electronic light sources 214 may be positioned to present an image to display. The electronic light sources 214 are configured to emit the light needed to render the image for display in accordance with an active backplane, e.g., the substrate 212. In one embodiment, the electronic light sources 214 may be LEDs. In some embodiments, the LEDs may be organic LEDs (OLEDS). In an alternative embodiment, the electronic light sources 214 may be other light-emitting pixels that are used in another conventional or later-developed FPD technology. Since the embodiment of FIG. 2 includes pixels of electronic light sources 214, the FPD 210 does not require a backlight to illuminate pixels of the FPD 210 to display an image. Those skilled in the pertinent art understand the structure and operation of conventional FPDs and the light-emitting pixels that are used to display images.

The active backplane directs the operation of each of the electronic light sources. The active backplane, not illustrated in detail in FIG. 2, may be partially or totally incorporated in the substantially transparent substrate 212. A first area, e.g., a central region, of each pixel on the substantially transparent substrate 212 may include the electronic light sources 214 thereon and one or more other substantially transparent regions 216 of each pixel may be able to transmit image light to the camera 230. In other embodiments, the active backplane for the electronic light sources 214 may be formed on a separate substrate from the substantially transparent substrate 212. The active backplane may include a matrix of thin film transistors (TFT) with each TFT driving and/or controlling a particular one of the electronic light sources 214 of a pixel. The active backplane may operate as a conventional array-type active backplane. In one embodiment, the active backplane may operate similar to an active backplane employed in an LCD display.

The camera 230 is also associated with the FPD 210 and is located on a backside of the FPD 210. Though FIG. 2 only schematically represents the camera 230, the camera 230 may take the form of an array-type charge-coupled device (CCD) solid-state camera equipped with a lens allowing it to capture an image from a focal plane that is beyond the FPD 210. Those skilled in the art will recognize that the camera 230 may be of any conventional or later-developed camera. Those skilled in the pertinent art also understand the structure and operation of such cameras, e.g., a conventional camera used in a videoconferencing terminal. The optical axis of the camera 230 faces (e.g., passes through a center of) the FPD 210. The camera 230 may be located at any distance from the FPD 210. However, in the illustrated embodiment, the camera 230 is located within 12 inches of the FPD 210. In an alternative embodiment, the camera 230 is located within four inches of the FPD 210. The camera 230 is configured to acquire its image substantially through or substantially only through the substantially transparent regions 216 of the pixels. The camera 230 may include circuitry and or software for processing of the captured images to remove undesired diffraction artifacts, e.g., via processing equivalent to optical spatial filtering. Accordingly, the camera 230 may be configured to perform post-processing of the captured images to increase clarity.

An object 240 lies on the frontside of the FPD 210, i.e., the side of the FPD 210 that is opposite the camera 230. In the illustrated embodiment, the object 240 includes a face of a participant in a videoconference. However, the object 240 may be any object whatsoever.

The arrows 250 signify the light emitted by the electronic light sources 214 bearing visual information to provide an image that can be viewed by the object 240. The camera 230 is configured to receive light, represented by the arrows 260, traveling from the object 240 through the FPD 210 and acquire an image of the object 240. As illustrated, the camera 230 receives the light 260 substantially through or substantially only through the substantially transparent regions 216. Although FIG. 2 does not show such, a backside surface of the FPD 210 may be rough or black to scatter or absorb the light such that it does not create a glare in the lens of the camera 230. For the same reasons, surface surrounding the camera 230 may also be black.

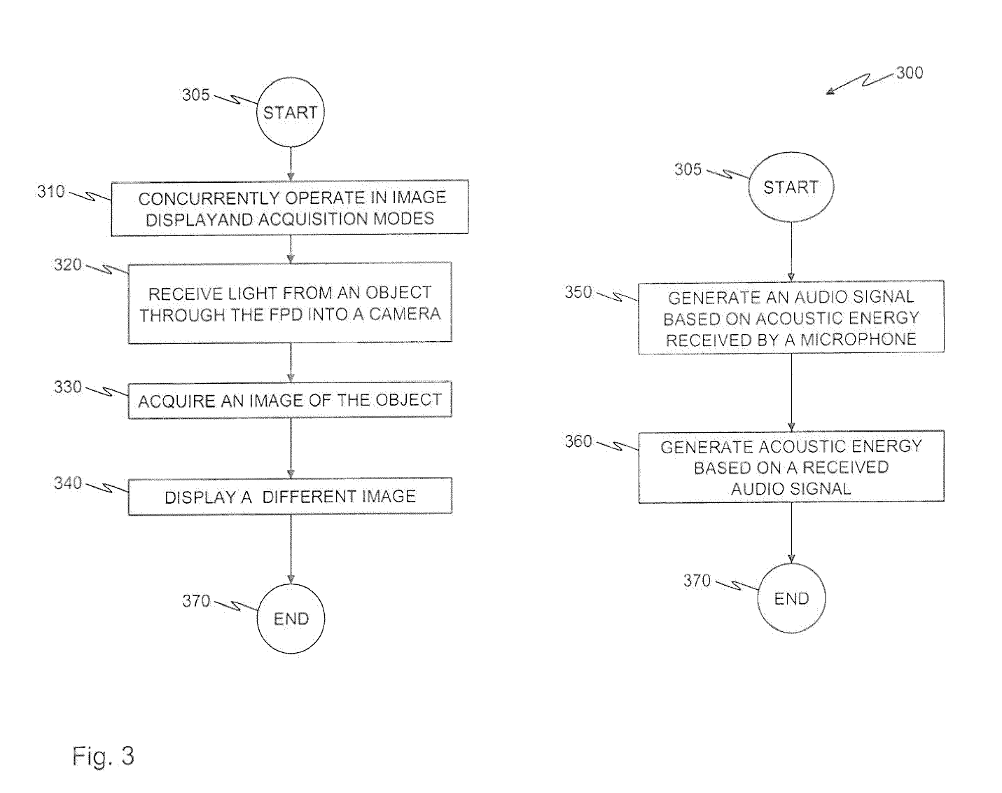

FIG. 3 is a flow diagram of one embodiment of a method 300 of videoconferencing carried out according to the principles of the invention. The method begins in a start step 305 and includes separate paths for the concurrent processing of video data and of audio data. In a step 310, an image display mode and an image acquisition mode are concurrently entered. In the image display mode, electronic light sources produce the light to form an image on the FPD. The electronic light sources may be fabricated on a substantially transparent substrate. In one embodiment, each electronic light source may include a set of light-emitting-diodes, e.g., for red, green, and blue light.

In the image acquisition mode, light from an object is received through substantially transparent regions interspersed among the electronic light sources. The electronic light sources and the substantially transparent regions may be arranged in a first array and a second array, respectively. In various embodiments, the electronic light sources of the first array are laterally interleaved with the substantially transparent regions of the second array. The electronic light sources may be arranged in a first regular two-dimensional (2D) array of pixels, and the substantially transparent regions may be arranged in a second regular 2D array, wherein each substantially transparent region of the second regular 2D array is a part of a pixel in the first regular 2D array.

Steps that may be performed in the image display mode and the image acquisition mode are now described. In the image acquisition mode, a camera may acquire an image through the FPD. Accordingly, in a step 320, light from an object (such as the viewer) is received through the FPD into the camera. In a step 330, the camera acquires an image of the object. The light from the object may be received substantially through only the transparent regions in the FPD into the camera, and the camera may acquire the image substantially through only the transparent regions in the FPD.

In the image display mode, an image is displayed in a step 340. The image may be a received image from, for example, a videoconferencing terminal that is remote to the FPD. Electronic light sources may produce light to form the different image on the FPD. The acquiring step 330 may be performed, e.g., concurrently with the displaying step 340. The method 300 can then end in a step 370.

Concurrent with the processing of video data, audio data may also be processed. As such, a microphone 360 generates an audio signal based on acoustic energy received thereby in a step 350. The microphone may be coupled to the FPD and the acoustic energy may be associated with the viewer. In a step 360, acoustic energy is generated based on an audio signal received thereby. The audio signal may be received from the same remote videoconferencing terminal that sends the image to display. The method 300 can then end in a step 370.

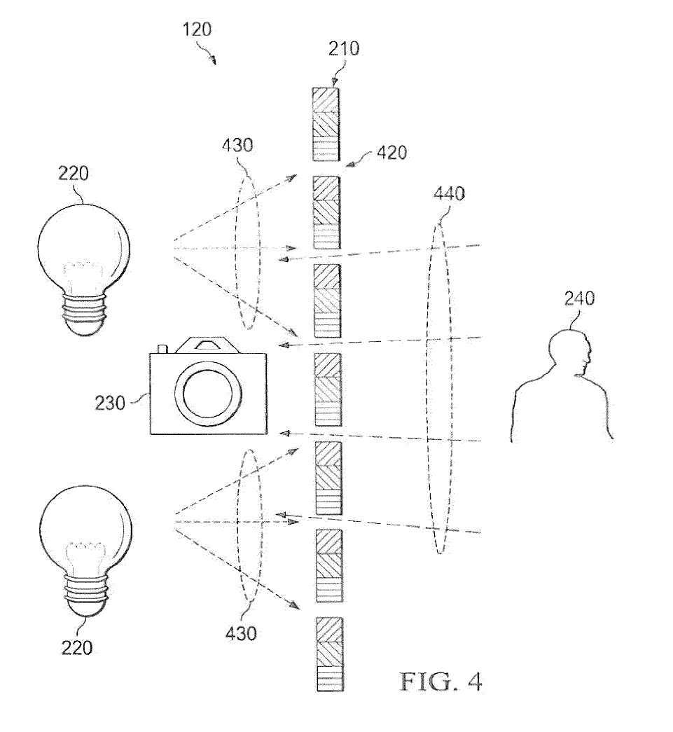

Refer now to FIG. 4, which is a schematic side elevation view of a second embodiment of a videoconferencing terminal, e.g., terminal 120, constructed according to the principles of the invention and operating in concurrent image display and image acquisition modes. The videoconferencing terminal 120 includes an FPD 210. In the illustrated embodiment, the FPD 210 includes a substantially transparent substrate (not shown in FIG. 4), e.g., substrate 212 described above, and a liquid crystal display (LCD) thereon. In an alternative embodiment, the FPD 210 includes a liquid-crystal-on-silicon (LCoS) display instead of the LCD. In further alternative embodiments, the FPD 210 includes a plasma display or is based on another conventional or later-developed FPD technology, instead. Those skilled in the pertinent art understand the structure and operation of conventional FPDs.

The FPD 210 of FIG. 4 includes substantially transparent regions 420 interspersed among its pixels, arranged in a first regular 2D array. In the embodiment of FIG. 4, substantially no liquid crystal is located in the substantially transparent regions 420, arranged in a second regular 2D array. In an alternative embodiment, liquid crystal is located in the substantially transparent regions 420, but the liquid crystal always remains substantially clear. In yet another alternative embodiment, regions 420 are apertures extending entirely through the FPD 210 or, in other words, openings therethrough.

The FPD 210 of FIG. 4 is illustrated as having an unreferenced associated color filter array (CFA). In this embodiment, the CFA is integral with the FPD 210 such that filter elements of the FPD 210 are colored (e.g., red, green and blue). Those skilled in the pertinent art understand the structure and operation of CFAs. In an alternative embodiment, the CFA is embodied in a layer adjacent to the FPD 210. In either embodiment, the CFA colors the pixels of the FPD 210, allowing the FPD 210 to display a color image, which may be a received image from, for example, a videoconferencing terminal (e.g., 130, 140 150) that is remote to the FPD 210. Various alternative embodiments of the videoconferencing terminal 120 lack the CFA and therefore employ the FPD 210 to provide a monochrome, greyscale, or “black-and-white,” image.

A backlight 220 is associated with the FPD 210. The backlight 220 is located on a backside of the FPD 210 and is configured to illuminate the FPD 210 when brightened. Though FIG. 4 schematically represents the backlight 220 as including a pair of incandescent lamps, the backlight 220 more likely includes a cold-cathode fluorescent backlight lamp (CCFL). However, the backlight 220 may be of any conventional or later-developed type. Those skilled in the pertinent art understand the structure and operation of backlights.

A camera 230 is also associated with the FPD 210 and is also located on its backside. Though FIG. 4 only schematically represents the camera 230, the camera 230 takes the form of a charge-coupled device (CCD) solid-state camera equipped with a lens allowing it to capture an image from a focal plane that is beyond the FPD 210. Those skilled in the art will recognize that the camera 230 may be of any conventional or later-developed type whatsoever. Those skilled in the pertinent art also understand the structure and operation of cameras such as may be used in a videoconferencing terminal. The optical axis of the camera 230 faces (e.g., passes through a center of) the FPD 210. The camera 230 may be located at any distance from the FPD 210 However, in the illustrated embodiment, the camera 230 is located within 12 inches of the FPD 210. In an alternative embodiment, the camera 230 is located within four inches of the FPD 210.

An object 240 lies on the frontside of the FPD 210, i.e., the side of the FPD 210 that is opposite the backlight 220 and the camera 230. In the illustrated embodiment, the object 240 includes a face of a participant in a videoconference. However, the object 240 may be any object whatsoever.

The camera 230 is configured to receive light from an object 240 through the FPD 210 and acquire an image of the object 240. It should be noted that if a CFA is present, it will also filter (color) the light from the object 240. However, since the CFA is assumed to be capable of generating a substantially full color range and further to be substantially out of the image plane of the camera 230, its filter elements (e.g., red, green and blue) average Out to yield substantially all colors.

In one embodiment, the camera 230 is configured to acquire its image substantially through only the substantially transparent regions 420. In another embodiment, the camera 230 is configured to acquire its image through both the substantially transparent regions 420 and remainder portions of the FPD 210 which are substantially transparent.

In the embodiment of FIG. 4. the backlight 220 operates continually, including while the camera 230 is acquiring one or more images. Accordingly, arrows 430 signify light traveling from the backlight 220 to the FPD 210 (and perhaps the CFA) and onward toward the object 240. Although FIG. 4 does not show such, a backside surface of the FPD 210 may be rough to scatter the light such that it does not create a glare in the lens of the camera 230. Arrows 440 signify light traveling from the object 240 through the FPD 210 (and perhaps the CFA) to the camera 230.

It should be noted that the FPD 210 of FIG. 4 includes substantially transparent regions 420 interspersed among pixels thereof. This allows the image display mode and image acquisition mode to occur concurrently. Light from an object (such as the viewer 240) is received substantially through the transparent regions 420 of the FPD 210 into the camera 230, and the camera thereby acquires an image of the object.

Referring also to FIG. 1, controller 165 of terminal 120 employs an audio-in signal to receive audio information from the microphone 161 and an audio-out signal to provide audio information to the speaker 163. The controller 165 is configured to combine a video-in signal from the camera 230 and the audio-in signal into an audio/video-out signal to be delivered, for example, to the telecommunications network 110. Conversely, the controller 165 is configured to receive a combined audio/video-in signal from, for example, the telecommunications network 110 and separate it to yield video-out and audio-out signals. The video-out signal is used to drive an FPD controller (not shown) to display an image of a remote object on the FPD 210. At the same time, the audio-out signal is used to drive an audio interface (not shown) to provide audio information to the speaker 163.

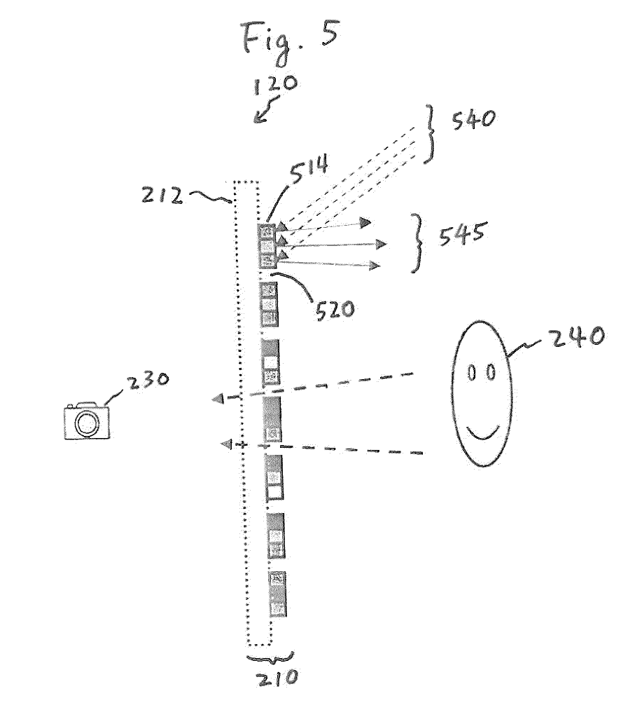

Refer now to FIG. 5, which is a schematic side elevation view of a third embodiment of a videoconferencing terminal, e.g., terminal 120, constructed according to the principles of the invention and operating in concurrent image display and image acquisition modes. The videoconferencing terminal 120 includes an FPD 210. In the illustrated embodiment, the FPD 210 includes a substantially transparent substrate 212 as described above, and display elements 514 based on light-reflective display technology to be described, which are 2-dimensionally arranged in such a manner to provide substantially transparent regions 520 interspersed among the display elements. In an alternative embodiment, the regions 520 are apertures extending entirely through the FPD 210 or, in other words, openings therethrough.

Display elements 514 of FPD 210 are used to display an image, which may be a received image from, for example, a remote videoconferencing terminal over telecommunications network 110. In one embodiment, display elements 514 each are a micro-electromechanical systems (MEMS) device composed of two conductive plates, which are constructed based on well known MEMS drive interferometric modulator (IMOD) technology, e.g., Qualcomm's Mirasol® display technology. One of these plates consists of a thin-film stack on a glass substrate, and the other plate consists of a reflective membrane suspended over the substrate, thereby forming an optical cavity between the two plates. Different voltages may be applied to the thin-film stack to vary the height of the optical cavity. When ambient light 540 hits a display element 514, depending on the height of its optical cavity, light of certain wavelengths reflecting off the reflective membrane would be slightly out of phase with light reflecting off the thin-film stack. Based on the phase difference, some wavelengths would constructively interfere, while others would destructively interfere. The resulting reflected light 545 affords a perceived color as certain wavelengths would be amplified with respect to others. A full-color image is realized by spatially ordering elements 540 reflecting in the red, green and blue wavelengths.

In another embodiment, the FPD 210 of FIG. 5 is realized based on well known electronic paper (c-paper) technology, e.g., electrophoretic display technology. In accordance with the latter technology, display elements 514 include charged pigment particles which can be re-arranged by selectively applying electric field to the elements to form a visible image. For example, in one implementation, display elements 514 contain titanium dioxide particles approximately one micrometer in diameter which are dispersed in a hydrocarbon oil. A dark-colored dye is also added to the oil, along with surfactants and charging agents that cause the particles to take on an electric charge. This mixture is placed between two parallel, conductive plates of display elements 514 which are separated by a gap of 10 to 100 μm. When a voltage is applied across the two plates, the particles migrate electrophorectically to the plate bearing the opposite charge from that on the particles. When the particles are located at the front (viewing) side of the display elements 514, reflected light 545 appears white resulting from scattering of ambient light 540 back to the viewer by the high-index titanium particles. When the particles are located at the rear side of the display elements 514, reflected light 545 appears dark resulting from absorption of ambient light 540 by the colored dye. Thus, using such display elements 540, an image can be formed by applying the appropriate voltage to each region of the FPD 210 to create a pattern of reflecting and absorbing regions.

Other embodiments of FPD 210 of FIG. 5 utilizing light-reflective display technology may include an LCD, a plasma display, etc., or may be based on another conventional or later-developed FPD technology. For example, in one embodiment, FPD 210 of FIG. 5 may be TFT LCD Model No. PQ 3Qi-01 made publicly available by Pixel Qi Corporation, which can operate in a reflective display mode.

In FIG. 5, a camera 230 is associated with the FPD 210 and located on its backside. Though FIG. 5 only schematically represents the camera 230, the camera 230 takes the form of a CCD solid-state camera equipped with a lens allowing it to capture an image from a focal plane that is beyond the FPD 210. Those skilled in the art will recognize that the camera 230 may be of any conventional or later-developed type whatsoever. Those skilled in the pertinent art also understand the structure and operation of cameras such as may be used in a videoconferencing terminal. The optical axis of the camera 230 faces (e.g., passes through a center of) the FPD 210. The camera 230 may be located at any distance from the FPD 210. However, in the illustrated embodiment, the camera 230 is located within 12 inches of the FPD 210. In an alternative embodiment, the camera 230 is located within four inches of the FPD 210.

In FIG. 5, an object 240 lies on the frontside of the FPD 210, i.e., the side of the FPD 210 that is opposite the camera 230. In the illustrated embodiment, the object 240 includes a face of a participant in a videoconference. However, the object 240 may be any object whatsoever. The camera 230 is configured to receive light from the object 240 through the FPD 210 and acquire an image of the object 240. In one embodiment, the camera 230 is configured to acquire its image substantially through only the substantially transparent regions 520. In another embodiment, the camera 230 is configured to acquire its image through both the substantially transparent regions 520 and remainder portions of the FPD 210 which are substantially transparent. The substantially transparent regions 520 allow the aforementioned image display mode and image acquisition mode to occur concurrently.

Referring also to FIG. 1, controller 165 of terminal 120 employs an audio-in signal to receive audio information from the microphone 161 and an audio-out signal to provide audio information to the speaker 163. The controller 165 is configured to combine a video-in signal from the camera 230 and the audio-in signal into an audio/video-out signal to be delivered, for example, to the telecommunications network 110. Conversely, the controller 165 is configured to receive a combined audio/video-in signal from, for example, the telecommunications network 110 and separate it to yield video-out and audio-out signals. The video-out signal is used to drive an FPD controller (not shown) to display an image of a remote object on the FPD 210. At the same time, the audio-out signal is used to drive an audio interface (not shown) to provide audio information to the speaker 163.

The foregoing merely illustrates the principles of the invention. It will thus be appreciated that those skilled in the art will be able to devise numerous arrangements which embody the principles of the invention and are thus within its spirit and scope.

For example, although videoconferencing terminal 120, as disclosed, is embodied in the form of various discrete functional blocks, such a terminal could equally well be embodied in an arrangement in which the functions of any one or more of those blocks or indeed, all of the functions thereof, are realized, for example, by one or more appropriately programmed processors or devices.

What is claimed is:

1. An apparatus, comprising:
a display device having thereon display elements for displaying a selected image, the display elements being arranged two-dimensionally on the display device such that light-transmissive regions are interspersed among the display elements on the display device; and
a camera configured on one side of the display device to receive light through the light-transmissive regions to capture an image of an object on the other side of the display device.

2. The apparatus of claim 1 wherein the light-transmissive regions are substantially transparent.

3. The apparatus of claim 1 wherein the light-transmissive regions comprise apertures through the display device.

4. The apparatus of claim 1 wherein the light-transmissive regions are arranged on the display device in a regular array.

5. The apparatus of claim 1 wherein the display elements are arranged on the display device in a regular array.

6. The apparatus of claim 1 wherein the display device includes a substantially transparent substrate, and the display elements are disposed on the substrate.

7. The apparatus of claim 1 wherein the selected image is displayed based on light-reflective display technology.

8. The apparatus of claim 7 wherein the display elements comprise micro-electromechanical systems (MEMS) devices.

9. The apparatus of claim 7 wherein the display elements comprise charged particles susceptible to an electric field.

10. The apparatus of claim 7 wherein the display device comprises a liquid crystal display (LCD)

11. An apparatus for communicating at least images, comprising:
a flat panel display comprising display elements for displaying thereon a first image received by the apparatus, and light-transmissive regions interspersed among the display elements; and
an optical device for providing a second image to be transmitted from the apparatus, the optical device being configured to receive light through the light-transmissive regions of the flat panel display to capture the second image.

12. The apparatus of claim 11 wherein the light-transmissive regions are substantially transparent.

13. The apparatus of claim 11 wherein the light-transmissive regions comprise apertures through the flat panel display.

14. The apparatus of claim 11 wherein the selected image is displayed based on light-reflective display technology.

15. The apparatus of claim 14 wherein the display elements comprise MEMS devices.

16. The apparatus of claim 14 wherein the display elements comprise charged particles susceptible to an electric field.

17. The apparatus of claim 14 wherein the display device comprises a LCD.

18. A method for use in a videoconferencing apparatus, the apparatus comprising a camera and a display device, the method comprising:
displaying a selected image using display elements on the display device, the display elements being arranged two-dimensionally on the display device such that light-transmissive regions are interspersed among the display elements on the display device; and
providing by the camera an image of an object on one side of the display device, the camera being configured on the other side of the display device to receive light through the light-transmissive regions to capture the image of the object.

19. The method of claim 18 wherein the light-transmissive regions are substantially transparent.

20. The method of claim 18 wherein the light-transmissive regions comprise apertures through the display device.
